(19) United States
(12) Patent Application Publication
(10) Pub. No.: US 2013/0103348 A1
(43) Pub. Date: Apr. 25, 2013

(54) METHODS AND APPARATUSES FOR CONTROLLING INVOCATION OF A SENSOR

(71) Applicants: Huanhuan Cao, Beijing (CN); Xueying Li, Beijing (CN); Jilei Tian, Beijing (CN)

(72) Inventors: Huanhuan Cao, Beijing (CN); Xueying Li, Beijing (CN); Jilei Tian, Beijing (CN)

(73) Assignee: NOKIA CORPORATION, Espoo (FI)

(21) Appl. No.: 13/807,725

(22) PCT Filed: Jun. 30, 2010
(86) PCT No.: PCT/CN2010/074814

§ 371 Date: Dec. 29, 2012

(51) Int. Cl. G06F 17/18

(52) U.S. Cl. CPC G06F 17/18
USPC 702/181

(57) ABSTRACT

Methods and apparatuses are provided for controlling invocation of a sensor. A method may include accessing a context probability model generated based at least in part on historical context data. The method may further include using the context probability model to determine a probability that a context indicated by an output of a sensor will differ from a context indicated by a previous output of the sensor. The determination may be made based at least in part on observed context information. The method may additionally include controlling invocation of the sensor based at least in part on the determined probability. Corresponding apparatuses are also provided.

### TECHNOLOGICAL FIELD

Embodiments of the present invention relate generally to context sensing technology and, more particularly, relate to methods and apparatuses for controlling invocation of a sensor.

### BACKGROUND

The modern computing era has brought about a tremendous expansion in computing power as well as increased affordability of computing devices. This expansion in computing power has led to a reduction in the size of computing devices and given rise to a new generation of mobile devices that are capable of performing functionality that only a few years ago required processing power provided only by the most advanced desktop computers. Consequently, mobile computing devices having a small form factor have become ubiquitous and are used for execution of a wide range of applications.

The widespread adoption of mobile computing devices and expanding capabilities of the wireless networks over which they communicate has further fueled expansion in the functionalities provided by mobile computing devices. In addition to providing telecommunications services, many mobile computing devices now provide functionalities such as navigation services, camera and video capturing capabilities, digital music and video playback, and web browsing. Some of the expanded functionalities and applications provided by modern mobile computing devices allow capture of user context information, which may be leveraged by applications to provide value-added context-based services to users. In this regard, mobile computing devices may implement applications that provide adaptive services responsive to a user's current context, as may be determined by data captured from sensors and/or other applications implemented on the mobile computing device.

While this expansion in functionality provided by mobile computing devices has been revolutionary, implementation and usage of the functionalities provided by modern mobile computing devices have been somewhat problematic for both developers and users of mobile computing devices. In this regard, these new functionalities provided by mobile computing device require additional power. In many instances, the additional power consumption required by a functionality may be quite substantial. This increased power consumption may be quite problematic for battery-powered mobile computing devices. In this regard, while battery life has improved, improvements in battery life have not kept pace with the virtually exponential growth in the capabilities of mobile devices. Accordingly, users of mobile computing devices may be forced to frequently recharge the battery or limit their usage, which may significantly degrade the user experience.

### BRIEF SUMMARY

Methods, apparatuses, and computer program products are herein provided for controlling invocation of a sensor. Methods, apparatuses, and computer program products in accordance with various embodiments may provide several advantages to computing devices and computing device users. Some example embodiments utilize historical context data for an apparatus to generate a context probability model. The context probability model is leveraged by some example embodiments to determine a probability that a context indicated by an output of a sensor will differ from a context indicated by a previous output of the sensor. For example, some example embodiments may leverage available context information from active sensors as input into a context probability model to determine a probability that a context indicated by an output of an inactive sensor will differ from a context indicated by the output of the sensor at a time when the sensor was previously invoked. In this regard, some example embodiments may control invocation of a sensor based on a determined probability that the output of the sensor, if invoked, will indicate a context that is different from a context indicated by a previous output of the sensor. Accordingly, unnecessary sampling and activation of sensors may be avoided, which may reduce power consumption by context-aware apparatuses, such as mobile computing devices, while still providing context information that may have a high probability of being current to context-aware applications and services. For example, in some example embodiments, a sensor may be activated to detect a context if and only if the context information captured by the sensor can offer significant information or value. In this regard, context information captured by a sensor may offer significant information or value if there is at least a threshold probability that the context information will not be redundant with previously captured context information (e.g., that a change in context has occurred). Accordingly, by predicting when context information that may be captured by a sensor is redundant, some example embodiments may reduce sensor activation and thus reduce power consumption while still providing meaningful context information.

In a first example embodiment, a method is provided, which comprises accessing a context probability model generated based at least in part on historical context data. The method of this example embodiment further comprises using the context probability model to determine a probability that a context indicated by an output of a sensor will differ from a context indicated by a previous output of the sensor. The determination of this example embodiment is made based at least in part on observed context information. The method of this example embodiment additionally comprises controlling invocation of the sensor based at least in part on the determined probability.

In another example embodiment, an apparatus is provided. The apparatus of this example embodiment comprises at least one processor and at least one memory storing computer program code, wherein the at least one memory and stored computer program code are configured, with the at least one processor, to cause the apparatus to at least access a context probability model generated based at least in part on historical context data. The at least one memory and stored computer program code are configured, with the at least one processor, to further cause the apparatus of this example embodiment to use the context probability model to determine a probability that a context indicated by an output of a sensor will differ from a context indicated by a previous output of the sensor. The determination of this example embodiment is made based at least in part on observed context information. The at least one memory and stored computer program code are configured, with the at least one processor, to additionally cause the apparatus of this example embodiment to control invocation of the sensor based at least in part on the determined probability.

In another example embodiment, a computer program product is provided. The computer program product of this example embodiment includes at least one computer-readable storage medium having computer-readable program instructions stored therein. The program instructions of this example embodiment comprise program instructions configured to access a context probability model generated based at least in part on historical context data. The program instructions of this example embodiment further comprise program instructions configured to use the context probability model to determine a probability that a context indicated by an output of a sensor will differ from a context indicated by a previous output of the sensor. The determination of this example embodiment is made based at least in part on observed context information. The program instructions of this example embodiment additionally comprise program instructions configured to control invocation of the sensor based at least in part on the determined probability.

In another example embodiment, a computer-readable storage medium carrying computer-readable program instructions is provided. The program instructions of this example embodiment comprise program instructions configured to access a context probability model generated based at least in part on historical context data. The program instructions of this example embodiment further comprise program instructions configured to use the context probability model to determine a probability that a context indicated by an output of a sensor will differ from a context indicated by a previous output of the sensor. The determination of this example embodiment is made based at least in part on observed context information. The program instructions of this example embodiment additionally comprise program instructions configured to control invocation of the sensor based at least in part on the determined probability.

In another example embodiment, an apparatus is provided that comprises means for accessing a context probability model generated based at least in part on historical context data. The apparatus of this example embodiment further comprises means for using the context probability model to determine a probability that a context indicated by an output of a sensor will differ from a context indicated by a previous output of the sensor. The determination of this example embodiment is made based at least in part on observed context information. The apparatus of this example embodiment additionally comprises means for controlling invocation of the sensor based at least in part on the determined probability.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates a block diagram of a context-aware apparatus for controlling invocation of a sensor according to an example embodiment of the present invention;

FIG. 2 is a schematic block diagram of a mobile terminal according to an example embodiment of the present invention;

FIG. 3 illustrates an example timing diagram of sensor invocation according to an example embodiment of the invention;

FIG. 4 illustrates a flowchart according to an example method for controlling invocation of a sensor according to an example embodiment of the invention; and

FIG. 5 illustrates a chip set or chip upon which an example embodiment of the present invention may be implemented.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention. As defined herein a “computer-readable storage medium,” which refers to a non-transitory, physical storage medium (e.g., volatile or non-volatile memory device), can be differentiated from a “computer-readable transmission medium,” which refers to an electromagnetic signal.

As used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present.

This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

Context-aware technology is used to provide intelligent, personalized, and context-aware applications to users. Mobile context sensing is an example of a platform on which when context-aware technology is implemented, context-aware applications may need to recognize the user's context from a variety of context sources and then take actions based on the recognized context.

However, any application in a battery-powered context-aware apparatus is faced with a discrete power constraint imposed by an amount of battery power remaining. Unfortunately, reducing power consumption in context-aware apparatuses is not a trivial problem because context sensing is naturally functioned as always-on. However, change of context for mobile user is not necessarily continuous, and may be discrete. In this regard, a mobile user's context stream may be segmented into several contexts (situations). Each context may last several minutes, or even hours. Such example contexts may include “waiting a bus”, “taking a bus”, “working in office”, and/or the like. Thus, within a particular context, some context data (e.g. location, transportation) may be stable and may not need to be sensed constantly, or even frequently.

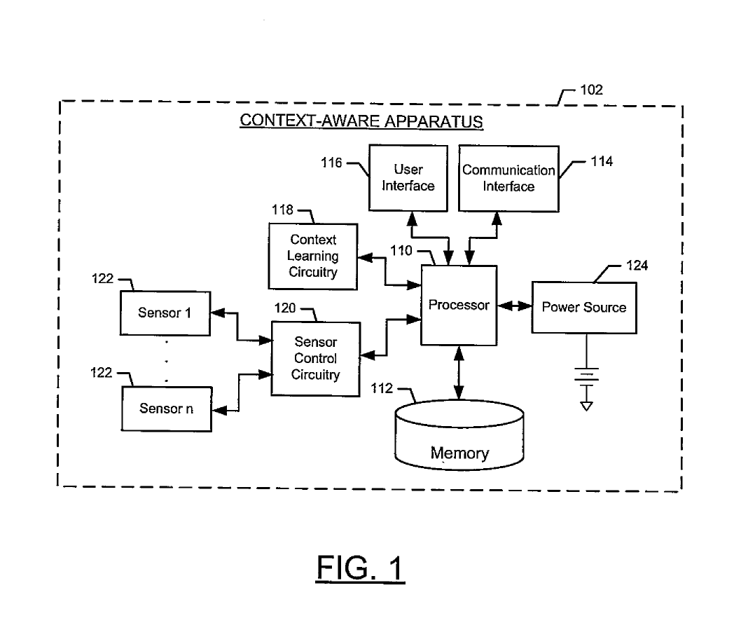

Some example embodiments described herein accordingly facilitate intelligently controlling invocation of a sensor. In this regard, some example embodiments may reduce power consumed by sensor invocation in context-aware apparatuses, while still providing context information deemed to be accurate with a relatively high level of confidence. FIG. 1 illustrates a block diagram of a context-aware apparatus 102 for controlling invocation of a sensor according to an example embodiment of the present invention. It will be appreciated that the context-aware apparatus 102 is provided as an example of one embodiment and should not be construed to narrow the scope or spirit of the invention in any way. In this regard, the scope of the disclosure encompasses many potential embodiments in addition to those illustrated and described herein. As such, while FIG. 1 illustrates one example of a configuration of an apparatus for controlling invocation of a sensor other configurations may also be used to implement embodiments of the present invention.

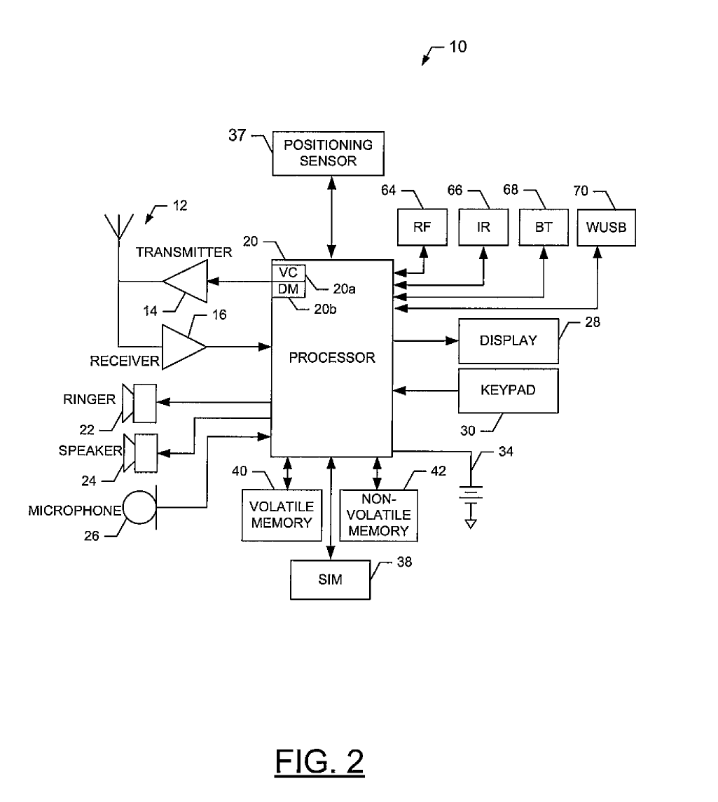

The context-aware apparatus 102 may be embodied as a desktop computer, laptop computer, mobile terminal, mobile computer, mobile phone, mobile communication device, one or more servers, one or more network nodes, game device, digital camera/camcorder, audio/video player, television device, radio receiver, digital video recorder, positioning device, any combination thereof, and/or the like. In an example embodiment, the context-aware apparatus 102 is embodied as a mobile terminal, such as that illustrated in FIG. 2.

In this regard, FIG. 2 illustrates a block diagram of a mobile terminal 10 representative of one embodiment of a context-aware apparatus 102. It should be understood, however, that the mobile terminal 10 illustrated and hereinafter described is merely illustrative of one type of context-aware apparatus 102 that may implement and/or benefit from embodiments of the present invention and, therefore, should not be taken to limit the scope of the present invention. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ embodiments of the present invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wireless-Fidelity, wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wireless Fidelity or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile terminal may comprise a battery 34 for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

As shown in FIG. 2, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to ultra-low power Bluetooth™ technology (e.g., Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wireless Fidelity, WLAN techniques such as IEEE 802.11 techniques, IEEE 802.15 techniques, IEEE 802.16 techniques, and/or the like.

The mobile terminal 10 may further include a positioning sensor 37. The positioning sensor 37 may include, for example, a global positioning system (GPS) sensor, an assisted global positioning system (Assisted-GPS) sensor, etc. In one embodiment, however, the positioning sensor 37 includes a pedometer or inertial sensor. Further, the positioning sensor may determine the location of the mobile terminal 10 based upon signal triangulation or other mechanisms. The positioning sensor 37 may be configured to determine a location of the mobile terminal 10, such as latitude and longitude coordinates of the mobile terminal 10 or a position relative to a reference point such as a destination or a start point. Information from the positioning sensor 37 may be communicated to a memory of the mobile terminal 10 or to another memory device to be stored as a position history or location information. Furthermore, the memory of the mobile terminal 10 may store instructions for determining cell id information. In this regard, the memory may store an application program for execution by the processor 20, which may determine an identity of the current cell (e.g., cell id identity or cell id information) with which the mobile terminal 10 is in communication. In conjunction with the positioning sensor 37, the cell id information may be used to more accurately determine a location of the mobile terminal 10.

It will be appreciated that the positioning sensor 37 is provided as an example of one type of context sensor that may be embodied on the mobile terminal 10. In this regard, the mobile terminal 10 may include one or more other context sensors in addition to or in lieu of the positioning sensor 37.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning to FIG. 1, in an example embodiment, the context-aware apparatus 102 includes various means for performing the various functions herein described. These means may comprise one or more of a processor 110, memory 112, communication interface 114, user interface 116, context learning circuitry 118, or sensor control circuitry 120. The means of the context-aware apparatus 102 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 112) that is executable by a suitably configured processing device (e.g., the processor 110), or some combination thereof.

The processor 110 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 1 as a single processor, in some embodiments the processor 110 comprises a plurality of processors. The plurality of processors may be in operative communication with each other and may be collectively configured to perform one or more functionalities of the context-aware apparatus 102 as described herein. The plurality of processors may be embodied on a single computing device or distributed across a plurality of computing devices collectively configured to function as the context-aware apparatus 102. In embodiments wherein the context-aware apparatus 102 is embodied as a mobile terminal 10, the processor 110 may be embodied as or comprise the processor 20. In an example embodiment, the processor 110 is configured to execute instructions stored in the memory 112 or otherwise accessible to the processor 110. These instructions, when executed by the processor 110, may cause the context-aware apparatus 102 to perform one or more of the functionalities of the context-aware apparatus 102 as described herein. As such, whether configured by hardware or software methods, or by a combination thereof, the processor 110 may comprise an entity capable of performing operations according to various embodiments while configured accordingly. Thus, for example, when the processor 110 is embodied as an ASIC, FPGA or the like, the processor 110 may comprise specifically configured hardware for conducting one or more operations described herein. Alternatively, as another example, when the processor 110 is embodied as an executor of instructions, such as may be stored in the memory 112, the instructions may specifically configure the processor 110 to perform one or more algorithms and operations described herein.

The memory 112 may comprise, for example, volatile memory, non-volatile memory, or some combination thereof. Although illustrated in FIG. 1 as a single memory, the memory 112 may comprise a plurality of memories. The plurality of memories may be embodied on a single computing device or may be distributed across a plurality of computing devices collectively configured to function as the context-aware apparatus 102. In various example embodiments, the memory 112 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the context-aware apparatus 102 is embodied as a mobile terminal 10, the memory 112 may comprise the volatile memory 40 and/or the non-volatile memory 42. The memory 112 may be configured to store information, data, applications, instructions, or the like for enabling the context-aware apparatus 102 to carry out various functions in accordance with various example embodiments. For example, in some example embodiments, the memory 112 is configured to buffer input data for processing by the processor 110. Additionally or alternatively, in some example embodiments, the memory 112 is configured to store program instructions for execution by the processor 110. The memory 112 may store information in the form of static and/or dynamic information. The stored information may include, for example, a context probability model, as will be further described herein. This stored information may be stored and/or used by the context learning circuitry 118 and/or sensor control circuitry 120 during the course of performing their functionalities.

The communication interface 114 may be embodied as any device or means embodied in circuitry, hardware, a computer program product comprising computer readable program instructions stored on a computer readable medium (e.g., the memory 112) and executed by a processing device (e.g., the processor 110), or a combination thereof that is configured to receive and/or transmit data from/to another computing device. In an example embodiment, the communication interface 114 is at least partially embodied as or otherwise controlled by the processor 110. In this regard, the communication interface 114 may be in communication with the processor 110, such as via a bus. The communication interface 114 may include, for example, an antenna, a transmitter, a receiver, a transceiver and/or supporting hardware or software for enabling communications with one or more remote computing devices. The communication interface 114 may be configured to receive and/or transmit data using any protocol that may be used for communications with a remote computing device. In this regard, the communication interface 114 may be configured to receive and/or transmit data using any protocol that may be used for transmission of data over a wireless network, wireline network, some combination thereof, or the like by which the context-aware apparatus 102 and one or more computing devices may be in communication. The communication interface 114 may additionally be in communication with the memory 112, user interface 116, context learning circuitry 118, and/or sensor control circuitry 120, such as via a bus.

The user interface 116 may be in communication with the processor 110 to receive an indication of a user input and/or to provide an audible, visual, mechanical, or other output to a user. As such, the user interface 116 may include, for example, a keyboard, a mouse, a joystick, a display, a touch screen display, a microphone, a speaker, and/or other input/output mechanisms. The user interface 116 may be in communication with the memory 112, communication interface 114, context learning circuitry 118, and/or sensor control circuitry 120, such as via a bus.

The context learning circuitry 118 may be embodied as various means, such as circuitry, hardware, a computer program product comprising computer readable program instructions stored on a computer readable medium (e.g., the memory 112) and executed by a processing device (e.g., the processor 110), some combination thereof, or the like. In some embodiments, the context learning circuitry 118 is embodied as or otherwise controlled by the processor 110. In embodiments wherein the context learning circuitry 118 is embodied separately from the processor 110, the context learning circuitry 118 may be in communication with the processor 110. The context learning circuitry 118 may further be in communication with one or more of the memory 112, communication interface 114, user interface 116, or sensor control circuitry 120, such as via a bus.

The sensor control circuitry 120 may be embodied as various means, such as circuitry, hardware, a computer program product comprising computer readable program instructions stored on a computer readable medium (e.g., the memory 112) and executed by a processing device (e.g., the processor 110), some combination thereof, or the like. In some embodiments, the sensor control circuitry 120 is embodied as or otherwise controlled by the processor 110. In embodiments wherein the sensor control circuitry 120 is embodied separately from the processor 110, the sensor control circuitry 120 may be in communication with the processor 110. The sensor control circuitry 120 may further be in communication with one or more of the memory 112, communication interface 114, user interface 116, or context learning circuitry 118, such as via a bus.

The sensor control circuitry 120 may further be in communication with one or more sensors 122. In this regard, the context-aware apparatus 102 may further comprise or otherwise be operably connected to one or more sensors, illustrated by way of example in FIG. 1 as sensor 1-sensor n, where n is an integer corresponding to the number of sensors 122. In embodiments wherein the context-aware apparatus 102 is embodied as a mobile terminal 10, the positioning sensor 37 may comprise a sensor 122. Although the sensors 122 are illustrated in FIG. 1 as being in direct communication with the sensor control circuitry 120, it will be appreciated that this illustration is by way of example. In this regard, the sensor control circuitry 120 may be indirectly coupled to a sensor 122, such as via the processor 110, a shared system bus, or the like. Accordingly, it will be appreciated that the sensor control circuitry 120 and a sensor 122 may be configured in any arrangement enabling the sensor control circuitry 120 to control invocation of the sensor. In this regard, the sensor control circuitry 120 may be configured to control invocation of a sensor by directly controlling invocation of the sensor, by providing invocation instructions to another means or entity (e.g., the processor 110, the sensor itself, and/or the like) controlling invocation of the sensor, some combination thereof, or the like.

The context-aware apparatus 102 may further comprise a power source 124, which may provide power enabling operation of one or more of the processor 110, memory 112, communication interface 114, user interface 116, context learning circuitry 118, sensor control circuitry 120, or one or more sensors 122. The power source 124 may comprise any means for delivering power to context-aware apparatus 102, or component thereof. For example, the power source 124 may comprise one or more batteries configured to supply power to the context-aware apparatus 102. Additionally or alternatively, the power source 124 may comprise an adapter permitting connection of the context-aware apparatus 102 to an alternative power source, such as an alternating current (AC) power source, a vehicle battery, and/or the like. In this regard, an alternative power source may be used to power the context-aware apparatus 102 and/or to charge a battery otherwise used to power the context-aware apparatus 102. In some example embodiments, the processor 110 and/or sensor control circuitry 120 may be configured to monitor the power source 124 to determine an amount of power remaining in the power source (e.g., in one or more batteries), whether the context-aware apparatus 102 is connected to an alternative power source, and/or the like. The processor 110 and/or sensor control circuitry 120 may be configured to use such information determined by monitoring the power source 124 to alter functionality of the context-aware apparatus 102. For example, invocation of a sensor may be controlled based on a status of the power source 124 (e.g., based on an amount of power remaining and/or based on whether the context-aware apparatus 102 is connected to an alternative power source).

Sensors, such as the sensor(s) 122 embodied on or otherwise operably coupled to the context-aware apparatus 102 may be divided into active sensors and invoked sensors in accordance with some example embodiments. Active sensors may comprise sensors consuming a relatively low amount of power and/or that are required for operation of applications other than context-aware applications. In this regard, active sensors may comprise sensors which may be kept active for at least a significant portion of the time during which the context-aware apparatus 102 is in operation. By way of illustrative example and not by way of limitation, active sensors may include sensors providing cellular service information (e.g., cell ID, global system for mobile communication (GSM) information), time information, system information, calendar/appointment information, and/or the like. Invoked sensors may comprise sensors consuming a relatively large amount of power and/or that are required only for operation of context-aware applications. By way of illustrative example and not by way of limitation, active sensors may include sensors providing positioning (e.g., GPS) information, audio information, 3-D accelerators, motion sensors, accelerometers, web service sensors, wireless sensors, wireless local area network (WLAN) detection sensors, and/or the like. It will be appreciated that embodiments of the context-aware apparatus 102 need not comprise each, or even any, of the illustrative example active sensors and invoked sensors set forth above. In this regard, the context-aware apparatus 102 may comprise a subset of the illustrative example sensors and/or may comprise other sensors in addition to or in lieu of one or more of the illustrative example sensors.

The context learning circuitry 118 may be configured to collect context information captured by sensors or otherwise available on the context-aware apparatus 102 and use the collected context information to generate and/or update a context probability model. In this regard, the context probability model may be configured to facilitate prediction of a probability that a context indicated by an output of a sensor will differ from a context indicated by a previous output of the sensor based at least in part on historical context information. A context indicated by an output of a sensor may, for example, comprise a context indicated directly by the output (e.g., the indicated context may comprise a value or other quality of the output). As another example, a context indicated by an output of a sensor may comprise a context that is indirectly indicated by the output of the sensor. In this regard, a context indicated by an output of a sensor may, for example, comprise a context that is derivable by processing and/or analyzing the output of the sensor. An output of a sensor may indicate a context different from a context indicated by a previous output of the sensor given any one or more of a variety of differences in a value of the output or information provided by the output. For example, an output of a sensor may indicate a context different from a context indicated by a previous output of the sensor if the output of the sensor changes in value (e.g., in signal level) from the previous output. As another example, an output of a sensor may indicate a context different from a context indicated by a previous output of the sensor if a level of information provided by the output differs from a level of information provided by the previous output. As a further example, an output of a sensor may indicate a context different from a context indicated by a previous output of the sensor if the output of the sensor and/or information indicated thereby differs semantically from the previous output of the sensor and/or information indicated thereby. Accordingly, the context probability model may be configured to facilitate prediction of a probability that invoking a sensor will result in capturing of information having additional value beyond that already known, such as from output captured by a previous invocation of the sensor. In this regard, invoking a sensor may, for example, result in capturing information having additional value, in an instance in which a context transition has occurred since the sensor was previously invoked.

For example, the context probability model may provide a probability classifier F based on historical context data that can output the probability that a context indicated by the output of a sensor (e.g., an invoked sensor) y changes given X which may be denoted as P(y|X), where X denotes available observed information. In this regard available observed context information may include context information of one or more active sensors, such as the values of the sensed data, time of the data, and/or the like. Available observed context information may further include recent observed context information from an invoked sensor other than y. In this regard, an observation of an invoked sensor that is presently active or that was captured within a predefined period of time (e.g., in the recent past) such that the observation may be deemed as current within an acceptable degree of accuracy may also be factored into a probability output by the probability model.

Accordingly, the context probability model may be derived from historical context information that may establish correlations between the output of an invoked sensor and other available context information, such as may be obtained from one or more active sensors and/or from one or more other invoked sensors. For example, the historical context information may establish that a user's location (e.g., the output of a GPS or other positioning sensor) does not generally change from 9:00 AM to 5:00 PM when the cell ID is 2344. Thus, there may be a high probability that the output of a positioning sensor (e.g., a context indicated thereby) will not change if the output of a time sensor is between the hours of 9:00 AM and 5:00 PM and the output of a cell ID sensor is 2344. Accordingly, such correlations may be used to generate a context probability model and/or train the context probability model to allow for a determination of a probability that a context indicated by an output of a sensor will change given the available observed context information.

The context probability model may be generated using any appropriate statistical model. By way of example and not by way of limitation, a naïve Bayes network, logistic regression model, some combination thereof, or the like may be used by the context learning circuitry 118 to generate and/or update the context probability model. A context probability model generated by the context learning circuitry 118 may be configured to output the probability that the context indicated by an output of any one of a plurality of modeled sensors may differ from a context indicated by a previous output. Alternatively, in some example embodiments, the context learning circuitry 118 may be configured to generate a plurality of context probability models, such as by generating a context probability model tailored to each of a subset of sensors whose invocation is controlled by the sensor control circuitry 120.

As will be appreciated, trends in evolution of context may change over time, such as when a user of a context-aware apparatus 102 changes jobs, moves to a new location, or the like. Further, accuracy of a determined probability of change in output of a sensor may be increased when determined based on a model factoring in additional historical context information. Accordingly, the context learning circuitry 118 may be configured to update a context probability model. In this regard, the context learning circuitry 118 may collect captured context information and use the captured context information to update a context probability model. Such updating may be performed in accordance with any defined criteria, such as periodically, in response to an occurrence of a predefined event, and/or the like.

The sensor control circuitry 120 may be configured to access a context probability model, such as by accessing a context probability model stored in the memory 112. The sensor control circuitry 120 may be configured to use a context probability model to determine a probability that a context indicated by an output of a sensor will differ from a context indicated by a previous output of the sensor. In this regard, the sensor control circuitry 120 may be configured to determine available observed context information and utilize the available observed context information as an input to the context probability model to determine a probability that a context indicated by an output of a sensor will differ from a context indicated by a previous output of the sensor. As discussed above, observed context information may include context information obtained from one or more active sensors. Additionally or alternatively, observed context information may include recent observed context information from an invoked sensor. In this regard, for example, an observation of an invoked sensor that is presently active or that was captured within a predefined period of time (e.g., in the recent past) such that the observation may be deemed as current within an acceptable degree of accuracy may also be used by the sensor control circuitry as an input to the context probability model.

The sensor control circuitry 120 may be further configured to control invocation of a sensor based at least in part on the determined probability. In some example embodiments, the sensor control circuitry 120 is configured to determine a sampling rate for a sensor based at least in part on the determined probability and control invocation of the sensor in accordance with the determined sampling rate. For example, the sensor control circuitry 120 may be configured to calculate a sampling rate for a sensory as:

SampleRate (y)=C*P(y|X), where C is a constant value. [1]

As described above, P(y|X) may denote the probability that the output of a sensor (e.g., an invoked sensor) y changes given X, where X denotes available observed information. The value of the constant C may be a constant value that is used for a plurality of invoked sensors. Alternatively, the value of the constant C may comprise a constant value that is specific to a particular sensor (e.g., the sensory). As one example, the value of the constant C may comprise a default sampling rate for the sensor. Accordingly, by using the equation [1] or otherwise determining a sampling rate for a sensor based on a determined probability that an output of the sensor will differ from a previous output of the sensor, the sensor control circuitry 120 may be configured to adjust a sampling rate such that the sampling rate is reduced if the probability of context transition is low and may be increased if there is a greater probability of context transition.

After having determined a sampling rate for a particular sensor, the sensor control circuitry 120 may be configured to update the sampling rate by again using the context probability model to determine a probability that an output of the sensor will differ from the previous output of the sensor. The sensor control circuitry 120 may be configured to determine an updated sampling rate periodically, such as after a predefined amount of time has passed since the last determination of the sampling rate, after a predefined number of invocations of the sensor in accordance with the previously determined sampling rate, or the like. For example, the sensor control circuitry 120 may be configured to cause invocation of a sensor in accordance with a determined sampling rate and then in response to invocation of the sensor, may be configured to re-calculate the probability that a context indicated by an output of the sensor will change and adjust the sampling rate prior to a subsequent invocation of the sensor.

As another example, in some embodiments the sensor control circuitry 120 may be configured to determine whether to invoke a sensor at a particular time or for a particular time period based on a determined probability that a context indicated by an output of the sensor will differ from a context indicated by a previous output of the sensor. For example, in an instance in which the determined priority meets or exceeds a predefined threshold probability (e.g., there is a relatively high probability of a context transition occurring since previous invocation of the sensor), the sensor control circuitry 120 may be configured to determine to invoke the sensor. Alternatively, in an instance in which the determined priority is less than the predefined threshold probability (e.g., there is a relatively low probability of a context transition occurring since previous invocation of the sensor), the sensor control circuitry 120 may be configured to determine to not invoke the sensor. In such embodiments, the sensor control circuitry 120 may, for example, be configured to determine whether to invoke a sensor at each occurrence of a discrete sampling time or sampling period (e.g., once every 5 minutes).

In determining how to control invocation of a sensor, the sensor control circuitry 120 may be further configured to factor in an amount of power available from the power source 124. For example, if the amount of power remaining in the power source 124 is below a predefined threshold, the sensor control circuitry 120 may be configured to reduce the sampling rate of a sensor. For example, equation [1] may be modified to take into account a variable value v determined based on an amount of power remaining in the power source 124, as follows:

SampleRate (y)=v*C*P(y|X). [2]

Accordingly, the sampling rate determined by the sensor control circuitry 120 may be scaled based on an amount of power remaining in the power source 124. As another example, the sensor control circuitry 120 may be configured to increase a sampling rate, or even leave an invoked sensor activated during a period in which the context-aware apparatus 102 is connected to an alternative power source.

As a further example, the sensor control circuitry 120 may be configured to factor in an amount of power required for invocation of a sensor when determining whether to invoke a sensor and/or when determining a sampling rate of the sensor. As an example, consider respective invoked sensors l and m, where/requires a greater amount of power for invocation than in. In an instance in which the probability of an output of the respective sensors l and m indicating a context transition is equal, the sensor control circuitry 120 may be configured to determine a sampling rate for the sensor l that is lower than a sampling rate determined for the sensor m. The sensor control circuitry 120 may, for example, be configured to factor in power consumption of a sensor by using the constant C in equation [1]. In this regard, in embodiments wherein C represents a default sampling rate for a sensor or is otherwise specific to a particular sensor, the value of C may represent a value scaled based at least in part upon the power consumption of its associated sensor.

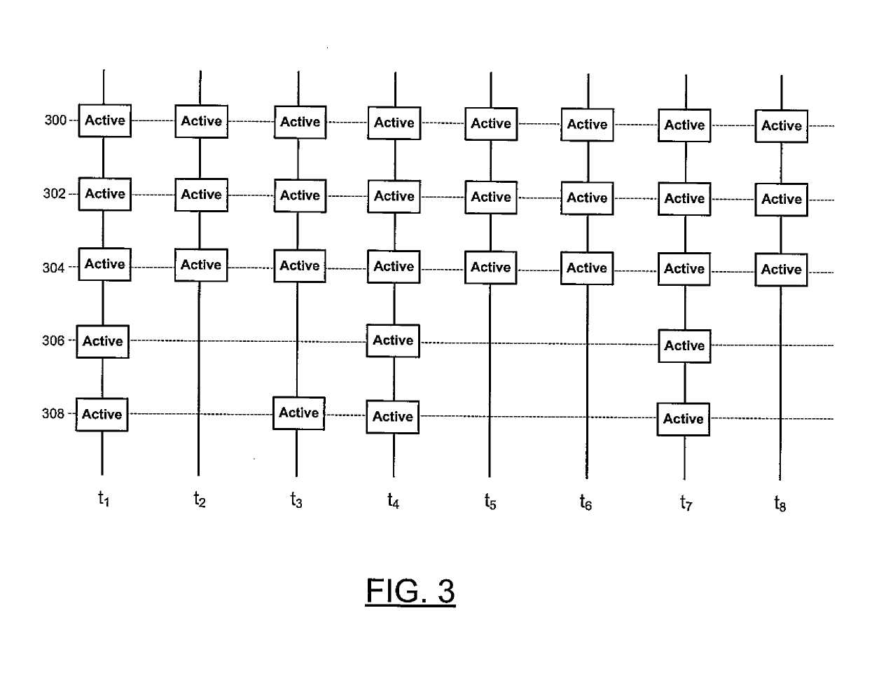

Referring now to FIG. 3, FIG. 3 illustrates an example timing diagram of sensor invocation according to an example embodiment. In this regard, FIG. 3 illustrates activation of five example sensors (sensors 300-308) at a plurality of sampling times (t₁-t₈). Each sampling time may represent a discrete moment in time, or may represent a window of time (e.g., a sampling period having a beginning moment in time and an ending moment in time). As illustrated in FIG. 3, a sensor is active at a particular sampling time if indicated as “Active.” If a sensor is not indicated as “Active” at a sampling time, then the sensor may be inactive (e.g., not invoked). Sensors 300, 302, and 304 are indicated as being “Active at each sampling time in FIG. 3. In this regard, sensors 300, 302, and 304 may comprise active sensors.

The sensor control circuitry 120 may, for example, use the output of the active sensors as input to a context probability model to control invocation of the sensors 306 and 308. In this regard, the sensors 306 and 308 may comprise invoked sensors whose invocation may be controlled by the sensor control circuitry 120 based on a probability that an output of the respective sensors 306 and 308 will differ from a previous output. Accordingly, as illustrated in FIG. 3, the sensors 306 and 308 may not be invoked at some of the illustrated sampling times, such as due to a determination of a relatively low probability of a change in context indicated by output of the sensor 306 and/or sensor 308. Further, the sampling rates of sensors 306 and 308 may be determined independently as illustrated in FIG. 3, wherein the sensor 306 is not invoked at sampling time t₃, but the sensor 308 is invoked at sampling time t₃. Additionally, FIG. 3, illustrates the sensor 306 being invoked at a consistent sampling rate (e.g., once every three sampling times), while the sensor 308 is not invoked at a consistent rate. In this regard, it will be appreciated the sensor control circuitry 120 may adjust a sampling rate of the sensor 308 due to a change in observed context information used to determine a probability of a change in context indicated by an output of the sensor 308. As another example, the sensor control circuitry 120 may determine whether to invoke the sensor 308 at each sampling time and control invocation of the sensor 308 based on the determination.

In an instance in which a context-aware application or service requests the output of an invoked sensor between samplings, the sensor control circuitry 120 may be configured to provide the previous output of the sensor and/or context indicated thereby as an estimation. Thus, for example, if a context-aware application were to request the output of sensors 306 and 308 at sampling time t₃, the sensor control circuitry 120 may provide the context-aware application with the output of the sensor 306 captured at sampling time t₁ as an estimation of the output of the sensor 306 at sampling time t₃, but may provide the actual captured output of the sensor 308 at sampling time t₃.

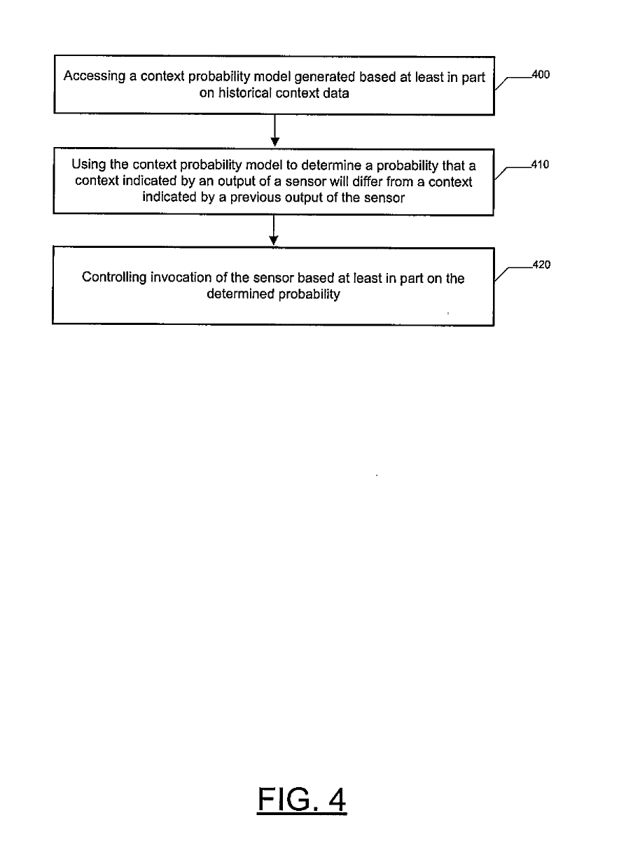

FIG. 4 illustrates a flowchart according to an example method for controlling invocation of a sensor according to an example embodiment of the invention. The operations illustrated in and described with respect to FIG. 4 may, for example, be performed by, with the assistance of, and/or under the control of one or more of the processor 110, memory 112, communication interface 114, user interface 116, context learning circuitry 118, or sensor control circuitry 120. Operation 400 may comprise accessing a context probability model generated based at least in part on historical context data. Operation 410 may comprise using the context probability model to determine a probability that a context indicated by an output of a sensor will differ from a context indicated by a previous output of the sensor. The determination may be made based at least in part on observed context information, such as current or recent context information available from other sensors. Operation 420 may comprise controlling invocation of the sensor based at least in part on the determined probability.

FIG. 4 is a flowchart of a system, method, and computer program product according to example embodiments of the invention. It will be understood that each block of the flowchart, and combinations of blocks in the flowchart, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device and executed by a processor in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories (e.g., the memory 112) on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (e.g., a context-aware apparatus 102) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions. It will also be understood that one or more blocks of the flowchart, and combinations of blocks in the flowchart, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor (e.g., the processor 110) may provide all or a portion of the elements. In another embodiment, all or a portion of the elements may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

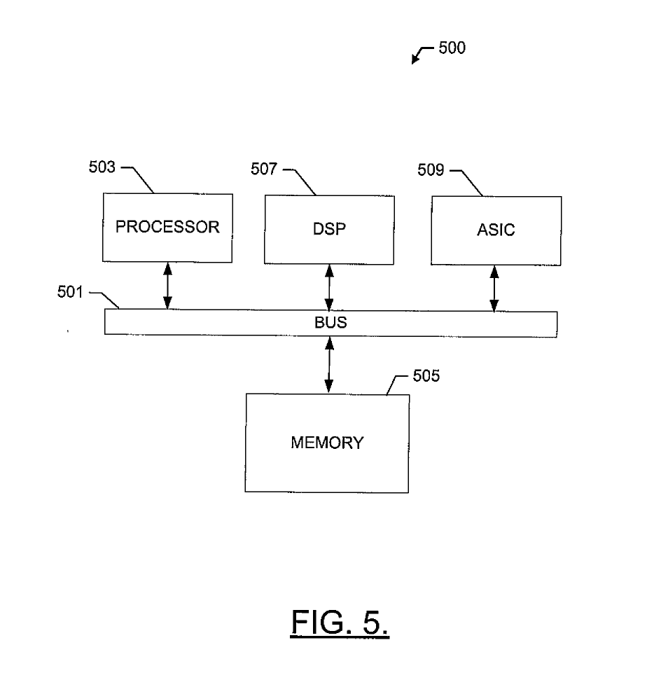

In some cases, example embodiments may be implemented on a chip or chip set. In this regard, FIG. 5 illustrates a chip set or chip 500 upon which an embodiment may be implemented. In an example embodiment, chip set 500 is programmed to control invocation of a sensor as described herein and may include, for instance, the processor, memory, and circuitry components described with respect to FIG. 1 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 500 can be implemented in a single chip. It is further contemplated that in certain embodiments the chip set or chip 500 can be implemented as a single “system on a chip.” It is further contemplated that in certain embodiments a separate ASIC would not be used, for example, and that all relevant functions as disclosed herein would be performed by a processor or processors. Chip set or chip 500, or a portion thereof, constitutes a means for performing one or more operations for controlling invocation of a sensor as described herein.

In one embodiment, the chip set or chip 500 includes a communication mechanism, such as a bus 501, for passing information among the components of the chip set 500. In accordance with one embodiment, a processor 503 has connectivity to the bus 501 to execute instructions and process information stored in, for example, a memory 505. The processor 503 may include one or more processing cores with each core configured to perform independently. A multi-core processor enables multiprocessing within a single physical package. Examples of a multi-core processor include two, four, eight, or greater numbers of processing cores. Alternatively or in addition, the processor 503 may include one or more microprocessors configured in tandem via the bus 501 to enable independent execution of instructions, pipelining, and multithreading. The processor 503 may also be accompanied with one or more specialized components to perform certain processing functions and tasks such as one or more digital signal processors (DSP) 507, or one or more application-specific integrated circuits (ASIC) 509. A DSP 507 typically is configured to process real-world signals (e.g., sound, video) in real time independently of the processor 503. Similarly, an ASIC 509 can be configured to perform specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 500 includes merely one or more processors and some software and/or firmware supporting and/or relating to and/or for the one or more processors.

In an example embodiment, the processor 503 and accompanying components have connectivity to the memory 505 via the bus 501. The memory 505 includes both dynamic memory (e.g., RAM, magnetic disk, writable optical disk, etc.) and static memory (e.g., ROM, CD-ROM, etc.) for storing executable instructions that when executed perform the inventive steps described herein to control invocation of a sensor. The memory 505 also stores the data associated with or generated by the execution of the inventive operations.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

1. A method comprising:
accessing a context probability model generated based at least in part on historical context data;
using the context probability model to determine a probability that a context indicated by an output of a sensor will differ from a context indicated by a previous output of the sensor, the determination being made based at least in part on observed context information; and
controlling invocation of the sensor based at least in part on the determined probability.

2. The method according to claim 1, wherein controlling invocation of the sensor comprises:
determining a sampling rate for the sensor based at least in part on the determined probability; and
controlling invocation of the sensor in accordance with the determined sampling rate.

3. The method according to claim 2, wherein determining a sampling rate for the sensor comprises determining the sampling rate further based on a constant value.

4. The method according to claim 3, wherein the constant value comprises a default sampling rate for the sensor.

5. The method according to claim 1, wherein controlling invocation of the sensor comprises:
determining whether to invoke the sensor based at least in part on the determined probability.

6. The method according to claim 5, wherein determining whether to invoke the sensor comprises:
determining to invoke the sensor in an instance in which the determined probability meets or exceeds a predefined threshold probability; and
determining to not invoke the sensor in an instance in which the determined probability is less than the predefined threshold probability.

7. The method according to claim 1, wherein the observed context information is derived from one or more active sensors.

8. The method according to claim 1, wherein controlling invocation of the sensor comprises controlling invocation of the sensor further based on an amount of power remaining in a power source configured to provide power to the sensor.

9. The method according to claim 1, wherein controlling invocation of the sensor comprises controlling invocation of the sensor further based on an amount of power required for invocation of the sensor.

10. The method according to claim 1, further comprising:
collecting captured context information; and
updating the context probability model based at least in part on the collected captured context information.

11. The method according to claim 1, wherein the historical context data comprises historical context data for a mobile terminal, and wherein the sensor is embodied on or is operably connected to the mobile terminal.

12. The method according to claim 1, wherein using the context probability model to determine a probability comprises a processor using the context probability model to determine a probability.

13. The method according to claim 1, wherein using the context probability model to determine a probability comprises sensor control circuitry using the context probability model to determine a probability.

14. An apparatus comprising at least one processor and at least one memory storing computer program code, wherein the at least one memory and stored computer program code are configured, with the at least one processor, to cause the apparatus to at least:
access a context probability model generated based at least in part on historical context data;
use the context probability model to determine a probability that a context indicated by an output of a sensor will differ from a context indicated by a previous output of the sensor, the determination being made based at least in part on observed context information; and
control invocation of the sensor based at least in part on the determined probability.

15. The apparatus according to claim 14, wherein the at least one memory and stored computer program code are configured, with the at least one processor, to cause the apparatus to control invocation of the sensor at least in part by:
determining a sampling rate for the sensor based at least in part on the determined probability; and
controlling invocation of the sensor in accordance with the determined sampling rate.

16. The apparatus according to claim 15, wherein the at least one memory and stored computer program code are configured, with the at least one processor, to cause the apparatus to determine the sampling rate further based on a constant value.

17. The apparatus according to claim 16, wherein the constant value comprises a default sampling rate for the sensor.

18. The apparatus according to claim 14, wherein the at least one memory and stored computer program code are configured, with the at least one processor, to cause the apparatus to control invocation of the sensor at least in part by:
determining whether to invoke the sensor based at least in part on the determined probability.

19. The apparatus according to claim 18, wherein the at least one memory and stored computer program code are configured, with the at least one processor, to cause the apparatus to:
determine to invoke the sensor in an instance in which the determined probability meets or exceeds a predefined threshold probability; and
determine to not invoke the sensor in an instance in which the determined probability is less than the predefined threshold probability.

20-38. (canceled)

38. A computer-readable storage medium carrying computer-readable program instructions, the computer-readable program instructions comprising:
program instructions configured to access a context probability model generated based at least in part on historical context data;
program instructions configured to use the context probability model to determine a probability that a context indicated by an output of a sensor will differ from a context indicated by a previous output of the sensor, the determination being made based at least in part on observed context information; and
program instructions configured to control invocation of the sensor based at least in part on the determined probability.

39-59. (canceled)
